(19) United States
(12) Patent Application Publication
(10) Pub. No.: US 2026/0108961 A1
(43) Pub. Date: Apr. 23, 2026

(54) CUTTING DEVICE FOR CUTTING FLAT MATERIAL

(71) Applicant: EVOBEND GmbH, AINRING (DE)

(72) Inventor: Nikolaus Franz DUSCHER, Bergheim bei Salzburg (AT)

(73) Assignee: EVOBEND GmbH, Ainring (DE)

(21) Appl. No.: 19/363,437

(22) Filed: Oct. 20, 2025

(30) Foreign Application Priority Data
Oct. 21, 2024 (DE) 10 2024 130 617.3

(51) Int. Cl. B23D 35/00

(52) U.S. Cl. CPC B23D 35/004; B23D 35/007

(57) ABSTRACT

A cutting device for cutting flat material, such as sheet metal, is disclosed. The cutting device includes a knife shaft to which at least one circular knife can be fastened and a positing device. The positioning device is configured to move the at least one circular knife in a released state along a longitudinal axis of the knife shaft and to fix it in a predetermined position on the knife shaft in a reversible and force-transmitting manner, wherein the positioning device has at least one effector configured to actuate a clamping means of the at least one circular knife. The cutting device is further characterized in that to actuate the clamping means, the effector is movable along an axis of movement that is skewed with respect to the longitudinal axis of the knife shaft.

### CROSS-REFERENCE TO RELATED APPLICATIONS

The present application claims priority from German Patent Application No. 10 2024 130 617.3 filed Oct. 21, 2024, the entire disclosure of which are incorporated herein by reference.

### TECHNICAL FIELD

The present invention relates to a cutting device for cutting flat material, such as sheet metal, comprising: a knife shaft to which at least one circular knife can be fastened; a positioning device configured to move the at least one circular knife in a released state along a longitudinal axis of the knife shaft and to fix it in a predetermined position on the knife shaft in a reversible and force-transmitting manner, wherein the positioning device has at least one effector configured to actuate a clamping means of the at least one circular knife.

### BACKGROUND

Such cutting devices are known from the prior art in the field of sheet metal machining. It is common practice to feed flat material, such as sheet metal, into such cutting devices to cut it longitudinally.

Conventional cutting devices used for cutting flat material longitudinally usually comprise one or more rotatable knife shafts on which roller knives are arranged. To achieve different cutting widths and thus accommodate different sheet metal formats, the positioning of the knives can often be adjusted. A corresponding cutting device is described, for example, in German utility model DE 203 06 757 U1. In accordance with the teachings of this utility model, a device for cutting material webs longitudinally is provided, which comprises an adjustment unit that enables roller knives to be adjusted axially. The adjustment unit is movable along the knife shafts and is controlled by a positioning unit such that the roller knives can be set in predefined positions automatically or without requiring manual adjustment. The device comprises a gripping unit and a screw unit for positioning the roller knives. The gripping device grips the roller knives and moves them into the desired position. After positioning, the screw unit secures the roller knives in place.

Such adjustment units require a lot of space, which poses a great challenge in terms of planning and operation. Conventional adjustment units require a lot of installation space, which limits their arrangement within the manufacturing environment. In existing factory layouts in particular, this may make new plant components difficult to integrate since there may be a lack of suitable space.

Moreover, the large amount of space required results in increased costs for the necessary infrastructure. In addition, the structural conditions and the generally poor accessibility also make it more difficult to maintain and inspect such machines, reducing the efficiency of maintenance work and potentially increasing downtime.

It is an object of the present invention to provide a cutting device of the aforementioned type with improved properties. It is another object of the present invention to provide a cutting device for cutting flat material that takes up little space and is very easy to use and maintain.

According to the invention, these objects are achieved with a cutting device of the aforementioned type, wherein to actuate the clamping means, the effector is movable along an axis of movement that is skewed with respect to the longitudinal axis of the knife shaft.

### DESCRIPTION OF THE INVENTION

Thus, according to the invention, the effector is movable along an axis of movement which neither intersects nor runs parallel to the longitudinal axis or, in other words, the axis of symmetry in the longitudinal direction or the axis of rotation of the knife shaft. This configuration provides a cutting device that has been improved to advantage. Due to the skewed orientation of the axis of movement of the effector relative to the longitudinal axis of the knife shaft, the effector does not occupy the entire diameter of the knife shaft, allowing for a particularly compact cutting device design that requires considerably less space. This enables flexible and/or space-saving integration of the cutting device into various working environments. In addition, the cutting device according to the invention is characterized by user-friendly maintenance processes that significantly reduce the effort required for maintenance, thus minimizing downtime.

In the context of the present invention, a clamping means is understood to be, in particular, a device configured to firmly and precisely hold a circular knife on the knife shaft before, while and/or after flat material is machined. The clamping means may comprise any devices and/or components that the skilled person deems advantageous for ensuring the position and stability of the circular knife on the knife shaft.

An “effector” is supposed to be, in particular, a sub-component and/or sub-portion of the positioning device. The effector may be configured to make physical contact and/or interact with one and/or more target objects, especially in the form of clamping means, at least occasionally. Depending on the requirements and/or task, the effector may be designed differently. In particular, the effector may be configured to tighten and/or loosen a clamping means.

In one embodiment, the positioning device may comprise a gripping unit that can be coupled to the at least one circular knife in a motion-transmitting manner. The gripping unit may form a unit that is spatially separated from the effector and/or have a separate actuator system. The gripping unit may be configured to securely enclose at least part of the outer circumferential surface of the circular knife and/or grip it at least at several contact points or contact areas to ensure a stable holding force. The gripping unit may comprise a gripping member configured to move radially toward at least one portion of an outer surface of the circular knife to surround at least part of it evenly. The gripping member may have a suitable contour to take into account the geometry of the circular knife and prevent slipping during movement or positioning. In addition, a non-slip coating of the gripping member may ensure a reliable form fit and/or improve grip before, while and/or after positioning the circular knife.

The effector and the gripping unit may be arranged on a plane of the positioning device that extends essentially perpendicular to the longitudinal axis of the knife shaft. This helps to achieve a particularly efficient use of installation space and a highly compact cutting device.

In an alternative embodiment, the at least one effector can be coupled to the at least one circular knife in a motion-transmitting manner. In other words, when coupled to the circular knife, the effector can move the circular knife along the knife shaft to any position. In such a configuration, the effector can therefore serve not only as an actuator to operate the clamping means but also as a kind of driver to also move the circular knife axially. This means that the effector according to the embodiment is multifunctional, rendering an additional gripping unit redundant. Preferably, the effector may be arranged in a plane of the positioning device that extends essentially perpendicular to the longitudinal axis of the knife shaft. Combining several functions into one single effector, such a multifunctional effector may significantly reduce the required installation space and manufacturing cost of the cutting device. This eliminates the need for additional machine components, enabling a more compact design of the cutting device. In addition, movement and changeover times are reduced because the effector can complete various tasks without changing tools. This increases the efficiency and flexibility of the cutting device.

In one embodiment, the positioning device may comprise a lifting/rotary module configured to move the effector along the axis of movement and rotate it about the axis of movement. The lifting/rotary module may comprise a lifting/rotary spindle. The lifting/rotary module may further comprise a ball screw nut and a torque ball bushing, each of which can be coupled via a belt drive to transmit motion. A distal end portion of the lifting/rotary spindle, i.e. an end portion of the lifting/rotary spindle facing the clamping means when the clamping means is actuated, may be configured as an effector. Alternatively, the distal end portion of the rotary/lifting spindle can be coupled to an effector in a motion and/or force-transmitting manner.

Such a lifting/rotary module comes with the advantage of combining both linear and rotary motion in a compact component. This allows for precise and/or synchronous control of either motion. Since the lifting and rotary motion is performed by a single spindle mechanism, there is less need for additional actuators and components, which saves space and reduces maintenance costs. In addition, the integration of both types of motion speeds up the process.

The gripping unit may comprise an adjustment device, such as a pneumatic cylinder, a hydraulic cylinder and/or an electric adjustment module, which is or can be coupled to the gripping unit in a motion-transmitting manner to reliably couple the positioning device or the gripping unit to the circular knife. The adjustment device may comprise a piston rod that is preferably linearly movable in an oscillatory manner along an axis perpendicular to the longitudinal axis of the knife shaft. The adjustment device can ensure precise, reliable, and/or rapid forward or backward movement of the gripping member to couple and/or decouple the circular knife.

In some embodiments, the cutting device may further comprise the at least one circular knife. The circular knife constitutes an independent aspect of the invention, which may also be provided independently of the cutting device or other features described in connection therewith.

The circular knife may comprise a knife holder as well as a circular blade that can be and/or is coupled to the knife holder in a captive manner. It is also conceivable that the circular blade is formed of multiple parts. Multi-part circular blades simplify assembly and/or disassembly, which, in particular, makes the circular knives very easy to maintain and replace. For example, during maintenance, the knife holders can remain on a shaft installed in a machine while only the circular blades are replaced without having to remove the shafts and/or knife holders. This minimizes downtime.

Preferably, the circular blade has a double-symmetrical configuration. The circular blade may have a circumferential cutting edge on each axial side. With cutting edges on both sides, the circular blade or circular knife can be used in either direction, which increases efficiency during use and doubles the circular knife's service life. In addition, when one cutting edge is worn down, the user or cutting device can simply switch to the other side, thus reducing maintenance and maximizing uptime.

The knife holder may be configured as a clamping ring or clamping sleeve. The knife holder may be configured as a one-piece or monolithic component or as a multi-piece component. Preferably, the knife holder has at least one gap extending from an axial side surface of the knife holder substantially in an L-shape, i.e. first in the axial direction and then in the tangential direction into the knife holder. The gap portion extending in the axial direction may be shorter than the gap portion extending in the tangential direction. The gap portion extending in the axial direction may be imagined as the short leg of an “L”, while the gap portion extending in the tangential direction may be imagined as the long leg of the “L”, which is curved. Preferably, the long leg extends in the tangential direction along a quarter of the substantially annular knife holder.

In some embodiments, the knife holder may additionally or alternatively comprise hydraulic components, such as hydraulic expansion chucks, to precisely and/or reliably clamp the knife holder to the knife shaft. Such hydraulic systems can ensure even clamping force distribution, achieving high stability and accuracy when clamping the knife holders.

The knife holder may comprise the clamping means, which is configured as a screw, for example. The knife holder may comprise at least one threaded bore into which the clamping means or screw can be inserted. The screw may be arranged in a threaded bore in the knife holder. For example, the screw and the threaded bore may be configured such that the screw in the knife holder bridges the gap portion extending in the axial direction. When the screw is actuated or tightened by the effector, the knife holder or sub-components of the knife holder may contract and/or expand, at least in sections, thus reducing the diameter of the knife holder, in particular the inner diameter. Preferably, the diameter of the knife holder is reduced at the point of the axial gap so that even circumferential tension is applied to the knife shaft. This ensures that force is reliably transmitted to the knife shaft. Similarly, the effector can release the force connection between the knife holder and the knife shaft by actuating or loosening the screw.

Further, the cutting device according to the invention may comprise any circular knives or knife holders of a design that the skilled person deems advantageous.

The knife holder may comprise a groove extending circumferentially at least in sections, which is configured as a complement to a gripping portion of the gripping unit. The groove may provide a precise fit for the gripping portion, ensuring secure and/or more stable coupling. Furthermore, such an interface improves the gripping force in the coupled state and prevents the gripping member from slipping or coming off the knife holder when under load during repositioning.

Moreover, in one embodiment, the knife holder may comprise at least one projection and/or indentation on an outer circumferential surface, which provides a reference for the alignment of the circular knife and/or the knife holder when it is repositioned by the positioning device. The projection or indentation plays a decisive role in the optimal alignment of the circular knife or knife holder. Such a “marking” may ensure the precise identification of circular knife or knife holder alignment for coupling to the effector and/or gripping device and may serve as a reliable indicator of optimal alignment. This can significantly reduce errors when repositioning the circular knives and downtime. At this point it should be noted that the indentation or projection is only to be understood as an example and that any other marking that the skilled person deems advantageous can be used.

In one embodiment, the positioning device may comprise at least one sensor configured to detect the at least one projection and/or indentation. Recognizing the projection or indentation or any other marking provided for the purpose of optimally aligning the circular knife, the sensor enables precise and rapid detection of the marking, allowing the cutting device to automatically respond in real time to the position and the state of the circular knife. For example, based on the information detected by the sensor, a shaft on which the knife to be repositioned is arranged can be rotated until the sensor detects the marking. This makes repositioning a circular knife faster and more precise as manual intervention is largely redundant.

In some embodiments, the positioning device may comprise a monitoring unit configured to monitor a gripping operation of the gripping unit. The monitoring unit may comprise one or more sensors configured to measure data, such as position, speed and/or force of the gripping device, to ensure that the gripping operation is performed efficiently, safely and/or successfully.

By using pressure sensors and/or position sensors and/or any other sensors that the skilled person deems advantageous, the monitoring unit may provide precise control over the gripping movements. In the event of deviations from predefined parameters, such as excessive force or incorrect positioning, an alarm may be triggered or the gripping unit may be put into a safe state. This considerably enhances operational safety and efficiency.

In one embodiment where the gripping function or gripping unit is integrated into the effector, the positioning device may also comprise a monitoring unit configured to monitor a coupling operation of the effector.

The cutting device may comprise at least one drive spindle arranged parallel to the longitudinal axis of the knife shaft and configured to move the positioning device parallel to the longitudinal axis of the knife shaft. Such an embodiment offers the advantage of high precision and reliability when repositioning the circular knife at all times. Its compact design allows for efficient use of space and simplifies integration into existing machines. Spindle drives can further achieve high adjustment speeds, speeding up the entire machining process.

Further, in addition to or as an alternative to the drive spindle, the cutting device may also comprise other or further drive elements that the skilled person deems advantageous, such as toothed racks and/or toothed belts, and that are configured to move the positioning device in parallel with the longitudinal axis of the knife shaft.

In one embodiment, the cutting device may further comprise: a further knife shaft arranged parallel to and spaced from the knife shaft; at least one further circular knife arranged on the further knife shaft; as well as at least one further positioning device configured to move the at least one further circular knife along a further longitudinal axis of the further knife shaft and to fix it in a predetermined position on the further knife shaft in a reversible and force-transmitting manner, wherein the further positioning device comprises: at least one further effector configured to actuate a further clamping means of the at least one further circular knife.

In this embodiment, to actuate the further clamping means of the at least one further circular knife, the further effector is movable along a movement axis that is skewed with respect to the longitudinal axis of the further knife shaft.

The further knife shaft, the further circular knife and the further positioning device may be identical in construction to the knife shaft, circular knife and positioning device described above. Similarly, the features of the embodiment described above are also applicable to the further cutting device components.

The cutting device may further comprise at least one further drive spindle arranged parallel to the further longitudinal axis of the further knife shaft and configured to move the further positioning device parallel to the further longitudinal axis of the further knife shaft. Being redundant, the drive spindle and positioning device allow circular knives on the knife shaft and further circular knives on the further knife shafts to be repositioned simultaneously and/or independently. This significantly reduces downtime for the cutting device.

Preferably, the further knife shaft is disposed above or below the knife shaft. In some embodiments, the knife shaft and the further knife shaft may have a depth offset.

In one embodiment, the cutting device may be configured to be switched to an active operating state and/or a passive operating state.

An active operating state is understood to mean a state or mode of the cutting device in which the at least two correspondingly arranged circular knives, hereinafter also referred to as a pair of knives, are arranged such that they are capable of cutting or configured to cut flat material in this knife position.

A passive operating state is understood to mean, in particular, a state or mode of the cutting device in which the circular knives are sufficiently spaced from each other in the vertical and/or horizontal spatial direction so that the circular knives do not perform a cutting function.

To switch from the passive to the active operating state and vice versa, the cutting device may comprise a lifting device configured to vary a distance between the knife shaft and the further knife shaft. In the active operating state, the circular knives and the further circular knives may be configured to overlap in axial alignment, which prevents the circular knives from repositioning or getting displaced or poses a risk of the circular knives getting damaged due to a displaced adjacent circular knife. The lifting device can be used to move the knife shafts and thus also the circular knives on the different shafts away from each other so that the circular knives are no longer axially aligned.

Depending on the operating situation, the circular knives or individual pairs of circular knives may be switched from an active operating state to a passive operating state at any time simply by spacing the circular knives sufficiently in the horizontal spatial direction or along the knife shafts using the positioning device, without having to space the knife shafts from each other using the lifting device.

Preferably, the cutting device may comprise an eccentric device coupled to one of the knife shafts in a motion-transmitting manner. The lifting device can be actuated by manual or automatic operation of the eccentric.

Preferably, the lifting height may be less than the backlash in a gear transmission configured to control the knife shafts. This means that the knife shaft and the further knife shaft are controllable at all times, including in the passive operating state.

In addition to gear transmissions, other drive components are conceivable to drive the knife shaft and the further knife shaft synchronously and/or independently of each other. Alternative drive components may include, for example, electric motors and/or drive shafts.

In one embodiment, the cutting device may further comprise a control unit configured to control the positioning device, the further positioning device, the knife shaft and/or the further knife shaft or transmissions coupled thereto. The control unit may comprise an operating pad. The operating pad enables intuitive and user-friendly operation, allowing for quick adjustment of settings or parameters directly on the cutting device. Remote control of the cutting device is also a possibility.

The control unit for the positioning device may operate based on the principle of a TARGET/ACTUAL comparison. First, a system with ACTUAL positions of the circular knives is initialized. The positioning unit, whose job it is to move the circular knives along the knife shafts, is then used for repositioning. To perform a repositioning operation, a TARGET position to which a specific circular knife is to be moved is specified. When the repositioning operation is started, the positioning device moves to the stored ACTUAL position of the relevant circular knife, detects it and moves it to the specified TARGET position. Once the circular knife is placed in the new position, the TARGET position is stored in the system as the new ACTUAL position to continuously document the updated position of the circular knives and make it available for future repositioning operations. This procedure is repeated for each repositioning operation.

The present invention further relates to a machine tool comprising a cutting device of any one of the preceding claims. Preferably, the cutting device may be designed for modular use. Such a modular cutting device offers the advantage of high manufacturing flexibility. It can be operated as a stand-alone unit or integrated into a production line to fit seamlessly into various process steps, such as punching or folding. Furthermore, the modular design allows for easy expansion or conversion of the production line, which reduces investment costs and saves installation space.

The invention further relates to a method for positioning a circular knife in a cutting device described above. The method according to the invention for positioning a circular knife offers the advantages discussed above in relation to the cutting device.

The method may comprise the steps: A) Entering a TARGET position for at least one of the circular knives; B) Aligning the positioning device relative to the circular knife to be repositioned in accordance with stored position information of the circular knife to be repositioned and/or an ACTUAL position; C) Aligning the circular knife in accordance with sensor data from the sensor; D) Gripping the circular knife by extending the gripping unit; E) Extending the effector in accordance with monitoring information from the monitoring unit; F) Rotating the effector by a defined angular amount and/or until a defined tightening torque is reached in order to loosen the clamping means; G) Moving the circular knife along the longitudinal axis of the knife shaft on which the corresponding circular knife is arranged to the TARGET position; H) Rotating the effector by a defined angular amount and/or until a defined tightening torque is reached in order to tighten the clamping means; I) Retracting the effector; J) and Retracting the gripping unit.

Steps D) and J) may be omitted in embodiments of the cutting device where the effector also serves as a gripping unit.

In one embodiment, the method may comprise step X) which involves switching the cutting device to a passive operating state by raising or lowering the upper and/or lower knife shafts so that a plurality of circular knives do not overlap in axial alignment. This step X) may precede step B). This step ensures, in particular, that two interacting knife shafts or circular knives arranged on them do not overlap or interfere with each other when repositioned in axial alignment in a cutting device.

The method may further comprise step Y) which involves switching the cutting device to an active operating state by lowering the upper and/or lower knife shafts so that a plurality of circular knives overlap at least partially in axial alignment. This step Y) may follow step J). This step ensures that, after repositioning, the circular knives are switched from the passive operating state back to the active operating state and/or become operatively coupled to each other. This step offers the advantage of reduced downtime as maintenance work can be completed efficiently, allowing the knives to be quickly reintegrated into the manufacturing process.

The devices and methods according to the invention shall not be limited to the applications and embodiments described above. In particular, they may have a number of individual elements, components and units that differ from a number specified herein to implement a functionality described herein. In addition, where ranges of values are specified in this disclosure, values within the specified limits should also be deemed to be disclosed and applicable.

Subsequently, the present invention is described by way of example with reference to the attached figures. The drawings, the description and the claims contain numerous features in combination. The skilled person will appropriately consider the features also individually and use them in useful combinations within the scope of the claims.

If there is more than one example of a particular object, only one of them may have a reference sign in the figures and in the specification. The description of this example can be correspondingly applied to the other examples of the object. In particular, when numerical words are used to describe objects, e.g. first, second, third object etc., they are used to name and/or assign objects. Accordingly, for example, there may be a first object and a third object, but no second object. However, numerical words could also be used to derive a number and/or a sequence of objects.

### BRIEF DESCRIPTION OF THE DRAWINGS

Below, the invention is explained by way of example with reference to the figures. In the drawings:

FIG. 1 is a spatial view of a machine tool including a cutting device;

FIG. 2 is a spatial view of the cutting device of FIG. 1;

FIG. 3 is a spatial view of a knife holder from a first perspective;

FIG. 4 is a spatial view of the knife holder of FIG. 3 from a second perspective;

FIG. 5 is a spatial view of the knife holder of FIG. 3 from a third perspective;

FIG. 6 illustrates the knife holder of FIG. 4 including circular blade;

FIG. 7 is a perspective longitudinal sectional view of a positioning device of FIG. 2 including a circular knife to be coupled;

FIG. 8 is a detailed view of the positioning device of FIG. 2 including sensor, monitoring unit and a circular knife to be coupled;

FIG. 9 is a cross-sectional view of the positioning device of FIG. 2 and a coupled circular knife;

FIG. 10 is a detailed view of a side view of a corresponding pair of circular knives of FIG. 2 in an active operating state;

FIG. 11 is a detailed view of a side view of the corresponding pair of circular knives of FIG. 10 in a passive operating state; and

FIG. 12 is a flow chart of a method for positioning a circular knife in a cutting device of FIG. 2.

### DETAILED DESCRIPTION OF THE INVENTION

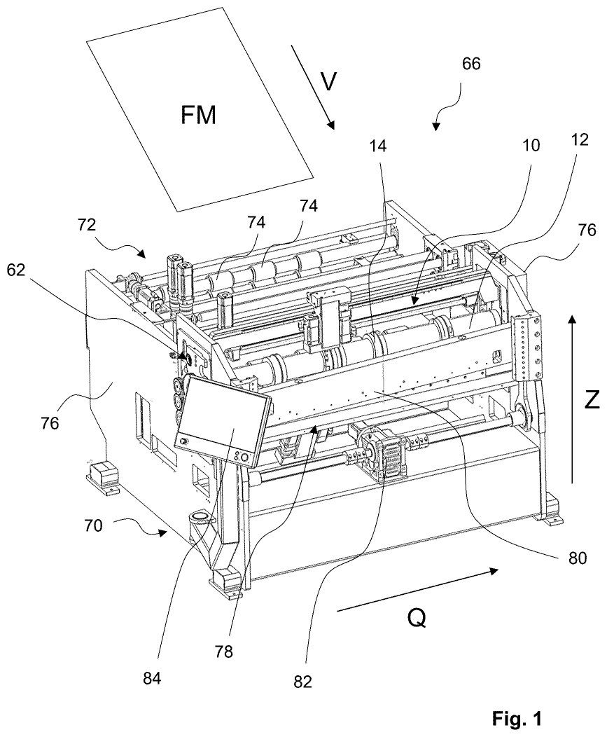

FIG. 1 is a perspective view of a machine tool 66 comprising a cutting device 10 according to the invention. In addition to the cutting device 10, the machine tool 66 comprises a base 70 which is firmly attached to a floor and which includes a support table 72 on which the flat material FM can be placed and displaced or straightened in a feed direction V. Guide rollers 74 which can be driven and between which the flat material FM can be passed are used for displacement. The flat material FM may, for example, be a sheet metal material. The base 70 further comprises two side walls 76 on which the support table 72 and the various guide rollers 74 are mounted.

The cutting device serves to cut the flat material in the longitudinal direction, i.e. in the feed direction V. Having passed through the cutting device 10, the flat material FM passes through a guillotine shearing device 78 that can be used to cut the flat material FM in the transverse direction Q. The guillotine shearing device 78 comprises a knife 80 that is displaceable in the height direction Z by one or more linear guide devices, such as screw drives and/or rack-and-pinion drives, or one or more eccentric drives 82 and/or other height adjustment devices the skilled person deems advantageous. The cutting device 10 comprises two knife shafts 12, 50 that are displaceable in the height direction Z by a lifting device 62 and on each of which a plurality of linearly displaceable circular knives 14, 52 are arranged. The lifting device 62 illustrated herein comprises at least one eccentric drive. In FIG. 1, the lower knife shaft 50 is mostly concealed by the guillotine shear 78.

In addition, an operating pad 84 is shown in FIG. 1 that can be used to send commands to control the machine tool 66 and/or monitor operating parameters of the machine tool 66.

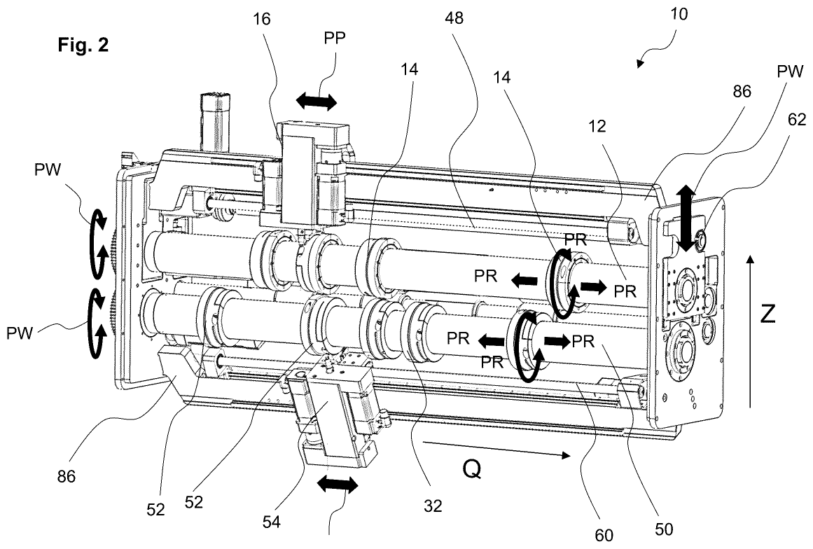

Details of the cutting device 10 can be seen in FIG. 2 in which the walls 76, the guillotine shear 78 as well as the support table 72 shown in FIG. 1 have been omitted to provide a better view of the inside of the cutting device 10. The cutting device 10 comprises two knife shafts 12, 50 that are arranged in parallel with each other in the spatial direction Z, one above the other. In the embodiment shown herein, the upper knife shaft 12 comprises four circular knives 14 that are arranged in different positions along the upper knife shaft. A total of five circular knives 52 can be seen on the lower knife shaft 50. In the state shown in FIG. 2, the second circular knife 14 from the left on the upper knife shaft 12 is operatively coupled to the second circular knife 52 from the left on the lower knife shaft 50. This means that the two knives 14, 52 form a pair of knives or a common cutting gap. The same applies to the third circular knife 14 from the left on the upper knife shaft 12 and the third circular knife 52 from the left on the lower knife shaft 50. All other circular knives 14, 52 are sufficiently spaced from adjacent circular knives 14, 52 and do not perform any cutting function in this state. Since the circular blades 32 of the circular knives 14, 52 have a double-symmetrical configuration, the circular knives 14, 52 may form variable pairs of knives at any time. Each circular knife 14, 52 may be positioned to form a common cutting gap with a circular knife 14, 52 arranged to its right and/or left.

A positioning device 16, 54 is provided in parallel with each of the knife shafts 12, 50. The upper positioning device 16 is configured to reposition the circular knives 14 on the upper knife shaft 12 as required, and the lower positioning device 54 is configured to reposition the circular knives 52 on the lower knife shaft 50 accordingly. While the upper positioning device 16 is arranged on a first plane with the knife shafts 12, 50, the lower positioning device 54 is arranged on a second plane that is at an angle to the first plane. Each of the positioning devices 16, 54 comprises a drive spindle 48, 60 that extends parallel and over almost the entire length of the respective knife shaft 12, 50, making the positioning devices 16, 54 displaceable along almost the entire length of the knife shafts 12, 50. The drive spindles 48, 60 are coupled to the respective positioning device 16, 54 in a motion-transmitting manner. There is a rail or a type of cross member 86 above and below the two drive spindles 48, 60 that is configured to bear the weight of the respective positioning device 16, 54, to align the positioning devices 16, 54 and/or to guide them. The degrees of freedom of the knife shafts 12, 50 are indicated by the arrows PW, the degrees of freedom of the positioning devices 16, 54 by the arrows PP, and the degrees of freedom of the circular knives 14, 52 by the arrows PR. For the sake of clarity, however, the arrows are not shown on all components of the cutting device 10.

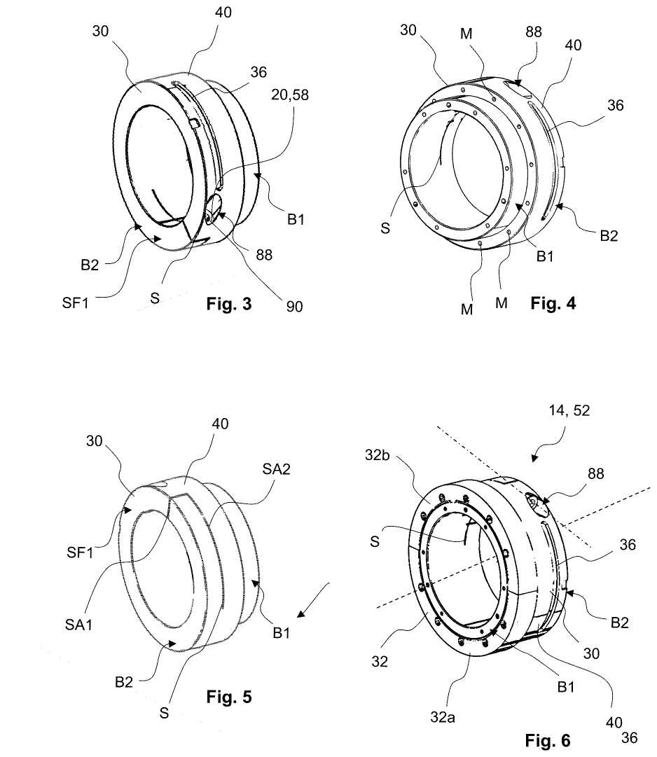

FIGS. 3 to 6 illustrate the structure of the circular knives 14, 52 shown in FIG. 2. In the embodiment shown herein, all of the circular knives 14, 52 are identical in construction. Each of the circular knives 14, 52 comprises a one-piece knife holder 30 as shown in FIGS. 3 to 4. The material thickness of the knife holder 30 varies in the axial direction. A section BI of the knife holder 30 having a smaller material thickness is configured for coupling to a circular blade 32. The circular blade 32 consists of a first blade half 32a and a second blade half 32b that, as can be seen in FIG. 6, are attached to the section D1 of the knife holder 30, which has the smaller material thickness, and are screwed to the knife holder 30 at designated mounting points M.

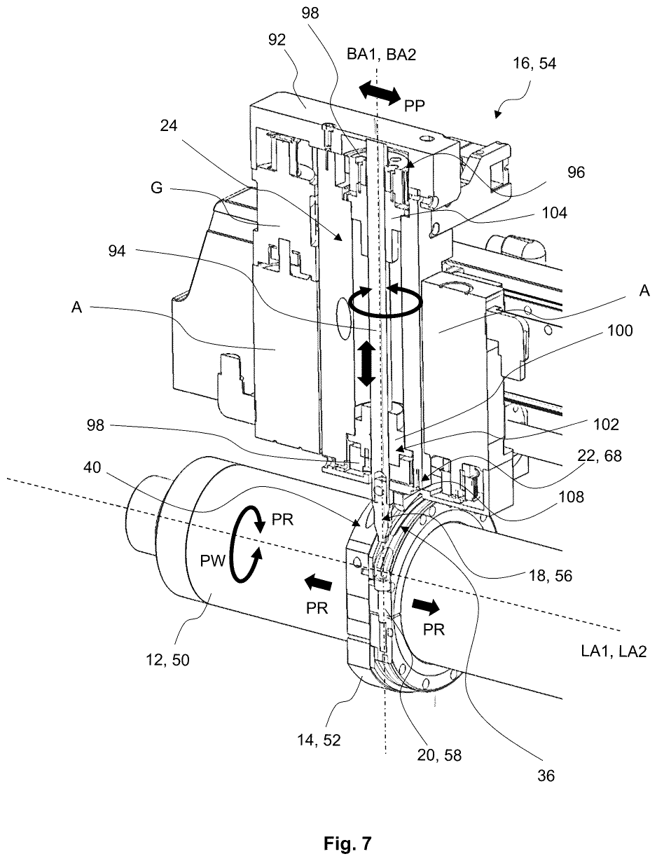

In a section D2 of the knife holder 30 where material thickness is greater, a groove 36 is provided on the outer circumferential surface 40 of the knife holder. This groove 36 is configured as a complement to a gripping portion 38 of a gripping unit 22, 68 of the positioning device 16, 54. FIGS. 7 to 9 illustrate how the groove 36 works. In addition to the groove 36, the knife holder 30 comprises an indentation 42 on the outer circumferential surface 40, which serves as a reference for the alignment of the circular knife 14, 52 when it is repositioned by the positioning device 16, 54.

As can be seen in FIG. 5, in the section D2 where material strength is greater, the knife holder 30 further comprises a gap S extending from an axial side surface SF1 of the knife holder 30 substantially in an L-shape, i.e. first in the axial direction and then in the tangential direction into the knife holder 30. The gap portion SA1 extending in the axial direction may be shorter than the gap portion extending in the tangential direction. The gap portion SA1 extending in the axial direction resembles a short leg of an “L”, and the gap portion SA2 extending in the tangential direction resembles the long leg of an “L”. The gap portion SA2 of the gap S, which extends in the tangential direction, has a curvature or the radius of curvature of the knife holder 30. In the embodiment shown herein, the long gap portion SA2 extends in the tangential direction along a quarter of the annular knife holder 30.

The knife holder 30 further comprises a threaded bore 88 with a clamping means 20, 58 in the form of a screw 90 arranged therein, which bridges the gap portion SA1 extending in the axial direction. The threaded bore 88 and the screw 90 are skewed with respect to a central axis of the knife holder 30. When the screw 90 is actuated or tightened by an effector 18, 56 of the positioning device 14, 54, the knife holder 30 may contract, which reduces the diameter of the knife holder 30 where the axial gap SA1 is located and applies even circumferential tension to the knife shaft 12, 50.

FIG. 7 is a perspective longitudinal sectional view of a positioning device 16, 54 of FIG. 2 including a circular knife 14, 52 to be coupled. It shows a sleeve or housing 92 of the positioning device 16, 54 in which a lifting/rotary module 24 is arranged. The lifting/rotary module 24 comprises a lifting/rotary spindle 94 that extends largely within the housing 92 of the positioning device 16, 54 and along an axis of movement BA1, BA2, skewed with respect to a longitudinal axis LA1, LA2 of a knife shaft 12, 50. A belt pulley 98 and a torque ball bushing 104 coupled to the belt pulley 98 to transmit motion are arranged at a proximal end portion 96 of the lifting/rotary spindle 94, i.e. an end portion 96 of the lifting/rotary spindle 94 facing away from a circular knife 14, 52 to be repositioned or the knife shaft 12, 50. A further pulley 98 with a corresponding ball screw nut 100 is arranged on a distal end portion 102 of the lifting/rotary spindle 94, i.e. an end portion facing the circular knife 14, 52 to be repositioned or the knife shaft 12, 50.

Furthermore, two drive units A in the form of electric motors are illustrated. The motor arranged on the left in the embodiment shown in FIG. 7 is coupled to the belt pulley 98 of the ball screw nut 100 via a transmission G and a belt (not illustrated herein), transmitting motion. In particular, the transmission G may be configured to alter a transmission ratio between one of the electric motors and the torque ball bushing 104 or the belt pulley 98, thereby amplifying or providing a higher torque. The motor arranged on the right in the embodiment shown in FIG. 7 is coupled directly to the belt pulley 98 of the ball screw nut 100 via a belt, transmitting motion.

By controlling the ball screw nut 100 and/or the torque ball bushing 104, combined motion sequences such as positioning, linear and/or rotary motion of the lifting/rotary spindle 94 can be generated. Compared to conventional systems consisting of many components, the lifting/rotary module 24 helps to reduce weight and save installation space.

An effector 18, 56 is coupled to the lifting/rotary spindle 24 at the distal end of the lifting/rotary spindle 24, transmitting motion. In the embodiment shown in FIG. 7, the effector 18, 56 is configured as a complement to the clamping means 20, 58. The effector 18, 56 is shown in FIG. 7 as an exemplary wrench 106 with an external hexagon profile. In the embodiment shown herein, the clamping means 20, 58 in the circular knife 14, 52 arranged on the knife shaft 12, 50 is configured as a correspondingly complementary hexagon socket.

FIG. 7 further illustrates a gripping member 108 of a gripping unit 22, 68 that comprises a contour configured as a complement to a groove 36 on the outer circumferential surface 40 of the knife holder 30 or a gripping portion 38 configured as a complement to a groove 36 on the outer circumferential surface 40 of the knife holder 30.

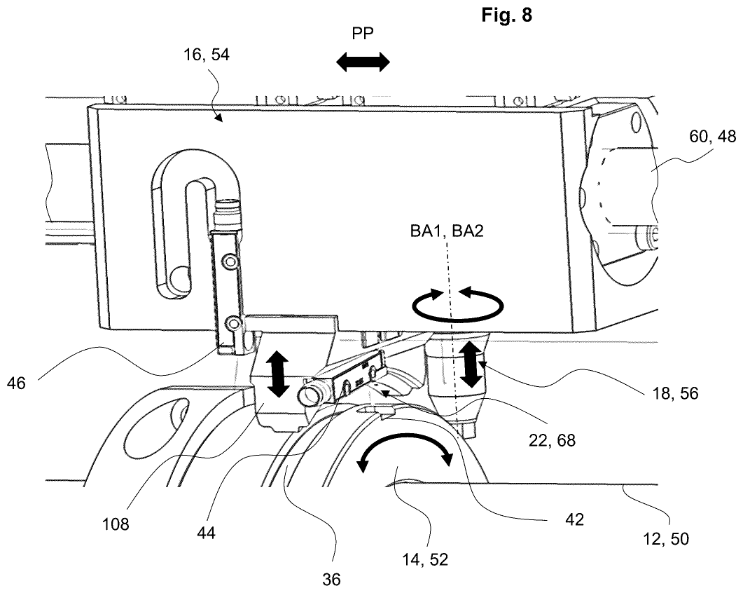

FIG. 8 is a detailed view of the positioning device 16, 54 of FIG. 2 including a sensor 44, a monitoring unit 46 as well as a circular knife 14, 52 to be coupled. The sensor 44 is arranged on the gripping member 108 and directed toward the knife shaft 12, 50 or the circular knife 14, 52. The sensor 44 is configured to detect a marking, which, in the embodiment shown herein, is an indentation 42. If, for example, the circular knife 14, 52 has been rotated by an angular amount such that the sensor 44 is unable to detect the indentation 42 and the gripping unit 22, 68 is unable to grip the circular knife 14, 52, the sensor 44 may initiate a rotational movement during repositioning by controlling the corresponding knife shaft 12, 50 on which the circular knife 14, 52 to be repositioned is arranged until the sensor 44 detects the indentation 42 and the circular knife 14, 52 is correctly aligned for repositioning. Once this is the case, the gripping member 108 is moved by linear motion toward the circular knife 14, 52 to be repositioned or the complementary groove 36 on the knife holder 30. A monitoring unit 46 configured to monitor a gripping operation of the gripping unit 22, 68 measures the motion and/or position of the gripping member 108. This measurement data is used to determine the point in time at which the gripping member 108 reliably engages with the groove 36 of the circular knife 14, 52.

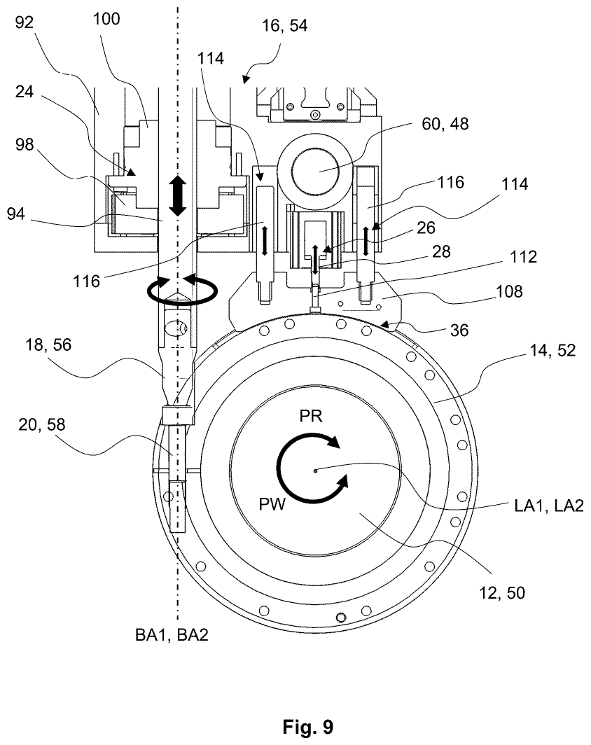

FIG. 9, a cross-sectional view of the positioning device 16, 54, shows a possible movement mechanism for the gripping member 108. It illustrates a pneumatic cylinder 26 which is embedded or integrated into the housing 92 of the positioning device 16, 54. The pneumatic cylinder 26 or its piston rod 28 is coupled to the gripping member 108 via a screw member 112 in a motion-transmitting manner. To ensure even movement of the gripping member 108, the positioning device 16, 54 further comprises two bearings 114 including two pins 116 that are coupled to the gripping member 108 to the left and right of the screw member 112.

Once the gripping member 108 has been successfully coupled to the circular knife 14, 52, as shown in FIG. 9, the lifting/rotary module 24 is actuated and the effector 18, 56 is brought into engagement with the clamping means 20, 58, i.e. the hexagon socket in the embodiment shown herein, in a linear movement along an axis of movement BA1, BA2 that is skewed with respect to the longitudinal axis LA1, LA2 of the knife shaft 12, 50 extending into the page. Finally, the lifting/rotary module 24 initiates a rotational movement and the clamping means 20, 58 is loosened.

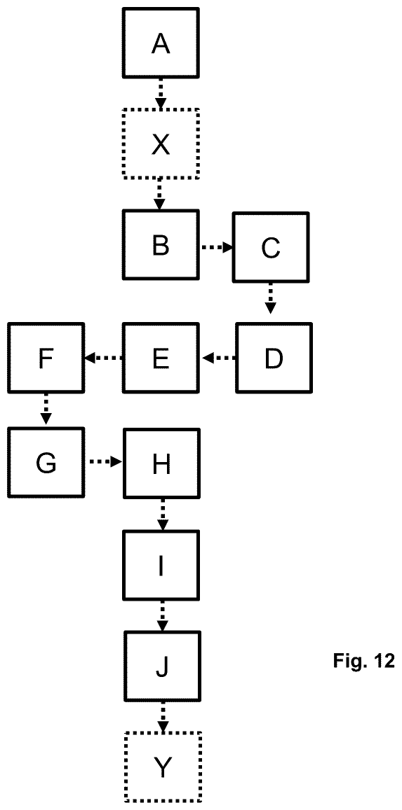

FIG. 12 illustrates a method for positioning a circular knife 14, 52 in a cutting device 10 described above. In step A), a TARGET position for at least one of the circular knives 14, 52 is entered. The entry can be made manually by an operator and/or automatically. In step B), the positioning device 16, 54 is aligned relative to the circular knife 14, 52 to be repositioned in accordance with stored position information of the circular knife 14, 52 to be repositioned and/or a current ACTUAL position of the circular knife 14, 52. This means that in step B), the positioning device is moved toward the circular knife 14, 52 to be repositioned. In the subsequent step C), the circular knife 14, 52 is aligned in accordance with sensor data from the sensor 44. Step C) may, in particular, involve rotating the knife shaft 12, 50 or the circular knife 14, 52 until the sensor 44 detects a reference and the circular knife 14, 52 is in a suitable position or alignment for repositioning. In step D), the gripping unit or the gripping member 108 extends to grip the circular knife 14, 52. Next, in step E), the effector 18, 56 is extended in accordance with monitoring information from the monitoring unit 46. This means that the effector 18, 56 will not extend until it is confirmed that the gripping member 108 has successfully engaged with the circular knife 14, 52. Subsequently, in step F), the effector 18, 56 is rotated by a defined angular amount and/or until a defined tightening torque is reached in order to loosen the clamping means 20, 58. Step F) is followed by step G) in which the positioning device 16, 54 moves the circular knife 14, 52 along the longitudinal axis LA1, LA2 of the knife shaft 12, 50 on which the corresponding circular knife 14, 52 is arranged to the TARGET position. Further, in step H), the effector 18, 56 is rotated by a defined angular amount and/or until a defined tightening torque is reached in order to tighten the clamping means 20, 58 and generate sufficient clamping force. Finally, in step I) and step J), the effector 18, 56 and the gripping unit or gripping member 108, respectively, are retracted.

FIG. 12 further illustrates optional steps X and Y. These steps may form part of the method for positioning circular knives 14, 52, particularly if the cutting device 10 comprises a further knife shaft with further circular knives 52.

Step X) may precede step B) and involve switching the cutting device 10 to a passive operating state by raising or lowering the knife shaft 12 and/or the further knife shaft 50 so that a plurality of circular knives 14, 52 do not overlap in axial alignment. The passive operating state shall refer to a state in which the cutting device 10 is specifically taken out of operation for maintenance or adaptations and/or to prevent the cutting of flat material. In this state, all safety and operating mechanisms are active to prevent any inadvertent movement or operation. The passive operating state allows the circular knives 14, 52 to be positioned and/or adjusted safely and precisely while avoiding the risk of them moving and/or becoming damaged during the procedure. This is particularly important because, in an active operating state, there is a close tolerance between the circular knives 14, 52 or the cutting edges 118 of the circular knives 14, 52 and any change in position or distance during operation could lead to malfunction or even damage.

Moreover, in step Y), the cutting device 10 can be switched back to an active operating state by raising or lowering the knife shaft 12 and/or the further knife shaft 50 so that a plurality of circular knives 14, 52 overlap at least partially in axial alignment. This step Y) may follow step J).

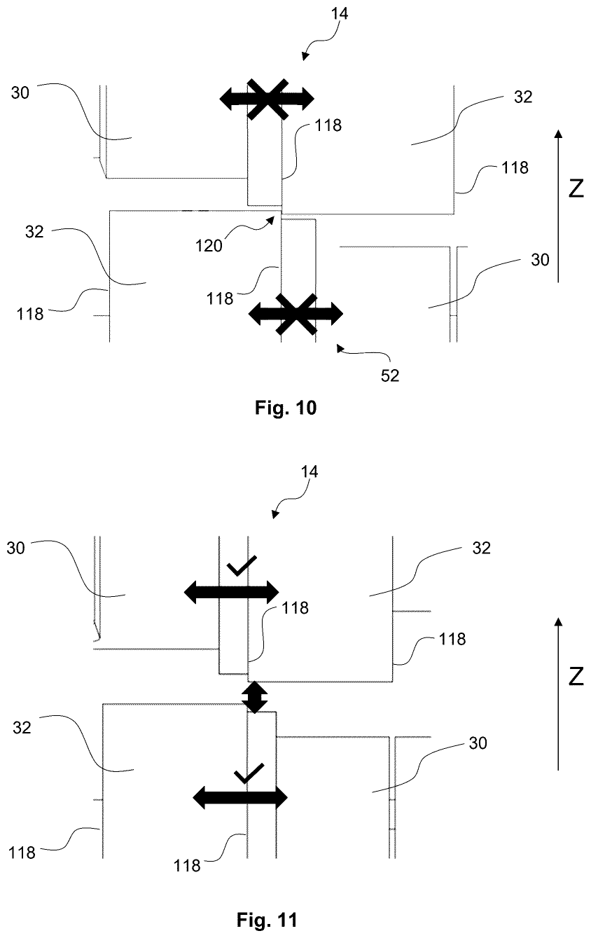

For a better illustration of steps X) and Y), reference is made to FIGS. 10 and 11. FIG. 10 shows a circular knife 14 and a further circular knife 52 in an active operating state. In this state, the circular knives 14, 52 or their circular blades 32 overlap partially in axial alignment. The circular knives 14 and 52 comprise two opposing cutting edges 118 between which a cutting gap 120 is formed in the active operating state. FIG. 11 shows the circular knife 14 and the further circular knife 52 of FIG. 10 in a passive operating state. In this state, the circular knives 14, 52 are spaced from each other in the height direction Z so that the circular blades 32 do not overlap in axial alignment and the circular knives 14, 52 do not interfere with each other during repositioning.

It should be noted at this point that additionally or alternatively, the cutting device 10 can also be switched from an active operating state to a passive operating state simply by ensuring there is sufficient distance between the circular knives 14, 52 along the knife shafts 12, 50 so that the circular knives 14, 52 are too far apart to have a cutting effect.

List of reference signs

| | | | |
|---|---|---|---|
| 10 | Cutting device | 78 | Guillotine shearing |
| | | | device |
| 12 | Knife shaft | 80 | Knife |
| 14 | Circular knife | 82 | Eccentric drive |
| 16 | Positioning device | 84 | Operating pad |
| 18 | Effector | 86 | Cross member |
| 20 | Clamping means | 88 | Threaded bore |
| 22 | Gripping unit | 90 | Screw |
| 24 | Lifting/rotary module | 92 | Housing |
| 26 | Pneumatic cylinder | 94 | Lifting/rotary spindle |
| 28 | Piston rod | 96 | Proximal end portion |
| 30 | Knife holder | 98 | Belt pulley |
| 32 | Circular blade | 100 | Ball screw nut |
| 32a, b | Blade half | 102 | Distal end |
| 34 | Clamping ring | 104 | Torque ball bushing |
| 36 | Groove | 106 | Wrench |
| 38 | Gripping portion | 108 | Gripping member |
| 40 | Outer circumferential | 112 | Screw member |
| | surface | | |
| 42 | Indentation | 114 | Bearing |
| 44 | Sensor | 116 | Pin |
| 46 | Monitoring unit | 118 | Cutting edge |
| 48 | Drive spindle | 120 | Cutting gap |
| 50 | Further knife shaft | A | Drive unit |
| 52 | Further circular knife | G | Transmission |
| 54 | Further positioning device | PW | Degree of freedom |
| 56 | Further effector | PR | Degree of freedom |
| 58 | Further clamping means | PP | Degree of freedom |
| 60 | Further drive spindle | D1 | Knife holder section |
| 62 | Lifting device | D2 | Knife holder section |
| 64 | Control unit | S | Gap |
| 66 | Machine tool | SA1 | Gap portion |
| 68 | Further gripping unit | SA2 | Gap portion |
| 70 | Base | SF1 | Side surface |
| 72 | Support table | M | Mounting point |
| 74 | Guide rollers | LA1 | Longitudinal axis |
| 76 | Wall | | |
| LA2 | Longitudinal axis | | |
| BA1 | Axis of movement | | |
| BA2 | Axis of movement | | |
| FM | Flat material | | |
| V | Feed direction | | |
| Q | Transverse direction | | |
| Z | Height direction | | |

What is claimed is:

1. A cutting device for cutting flat material, such as sheet metal, comprising:
a knife shaft to which at least one circular knife can be fastened;
a positioning device configured to move the at least one circular knife in a released state along a longitudinal axis of the knife shaft and to fix it in a predetermined position on the knife shaft in a reversible and force-transmitting manner, wherein the positioning device has at least one effector configured to actuate a clamping means of the at least one circular knife;
characterized in that to actuate the clamping means, the effector is movable along an axis of movement that is skewed with respect to the longitudinal axis of the knife shaft.

2. The cutting device of claim 1, wherein the positioning device comprises a gripping unit that can be coupled to the at least one circular knife in a motion-transmitting manner.

3. The cutting device of claim 1, wherein the at least one effector can be coupled to the at least one circular knife in a motion-transmitting manner.

4. The cutting device of claim 1, wherein the positioning device comprises a lifting/rotary module configured to move the effector along the axis of movement and rotate it about the axis of movement.

5. The cutting device of claim 2, wherein the positioning device comprises a pneumatic cylinder and/or a hydraulic cylinder including a piston rod that is coupled to the gripping unit in a motion-transmitting manner.

6. The cutting device of claim 1, further comprising the at least one circular knife including a knife holder as well as a circular blade that can be and/or is coupled to the knife holder in a captive manner.

7. The cutting device of claim 6, wherein the knife holder is configured as a clamping ring.

8. The cutting device of claim 6, wherein the knife holder comprises a groove extending circumferentially at least in sections, which is configured as a complement to a gripping portion of the gripping unit.

9. The cutting device of any one of claim 6, wherein the knife holder comprises at least one projection and/or at least one indentation on its outer circumferential surface which provides a reference for the alignment of the circular knife when it is repositioned by the positioning device.

10. The cutting device of claim 9, wherein the positioning device comprises at least one sensor configured to detect the at least one projection and/or the at least one indentation.

11. The cutting device of any one of claim 2, wherein the positioning device comprises a monitoring unit configured to monitor a gripping operation of the gripping unit.

12. The cutting device of claim 1, wherein the positioning device comprises a monitoring unit configured to monitor a coupling operation of the effector.

13. The cutting device of claim 1, further comprising at least one drive spindle arranged parallel to the longitudinal axis of the knife shaft and configured to move the positioning device parallel to the longitudinal axis of the knife shaft.

14. The cutting device of claim 1, further comprising:
a further knife shaft arranged parallel to and spaced from the knife shaft;
at least one further circular knife arranged on the further knife shaft; as well as
at least one further positioning device configured to move the at least one further circular knife along a longitudinal axis of the further knife shaft and to fix it in a predetermined position on the further knife shaft in a reversible and force-transmitting manner,
wherein the further positioning device comprises at least one further effector configured to actuate a further clamping means of the at least one further circular knife;
characterized in that to actuate the further clamping means of the at least one further circular knife, the further effector is movable along a movement axis that is skewed with respect to the longitudinal axis of the further knife shaft.

15. The cutting device of claim 14, further comprising at least one further drive spindle arranged parallel to the longitudinal axis of the further knife shaft and configured to move the further positioning device parallel to the longitudinal axis of the further knife shaft.

16. The cutting device of claim 14, further comprising a lifting device configured to vary a distance between the knife shaft and the further knife shaft.

17. The cutting device of any one of the preceding claims, further comprising a control unit configured to control the positioning device, the further positioning device, the knife shaft and/or the further knife shaft.

18. A machine tool comprising a cutting device of any one of the preceding claims.

19. A method for positioning the circular knife in the cutting device of claim 2, comprising the steps of:
A) Entering a TARGET position for at least one of the circular knives;
B) Aligning the positioning device relative to the circular knife to be repositioned in accordance with stored position information of the circular knife to be repositioned and/or an ACTUAL position;
C) Aligning the circular knife in accordance with sensor data from the sensor;
D) Gripping the circular knife by extending the gripping unit;
E) Extending the effector in accordance with monitoring information from the monitoring unit;
F) Rotating the effector by a defined angular amount and/or until a defined tightening torque is reached in order to loosen the clamping means;
G) Moving the circular knife along the longitudinal axis of the knife shaft on which the corresponding circular knife is arranged to the TARGET position;
H) Rotating the effector by a defined angular amount and/or until a defined tightening torque is reached in order to tighten the clamping means;
I) Retracting the effector; and
J) Retracting the gripping unit.

20. The method of claim 19, wherein step X) which involves switching the cutting device to a maintenance state by raising or lowering the knife shaft and/or the further knife shaft so that a plurality of circular knives do not overlap in axial alignment precedes step B).

21. The method of claim 20, wherein step J) is followed by step Y) which involves switching the cutting device to an operating state by lowering the knife shaft and/or the further knife shaft so that a plurality of circular knives overlap at least partially in axial alignment.
